(19) United States
(12) Patent Application Publication
(10) Pub. No.: US 2024/0278430 A1
(43) Pub. Date: Aug. 22, 2024

(54) Robotic Applicator Coating System and Method

(71) Applicant: Vitro Automatizacion, S.A. de C.V., Monterrey (MX)

(72) Inventors: Adrián Enrique Macouzet Díaz Leal, Tlalnepantla (MX); Juan Salvador Farias Garza, San Pedro (MX); Gustavo Abraham Chavez Guerrero, Monterrey (MX)

(21) Appl. No.: 18/582,084

(22) Filed: Feb. 20, 2024

Related U.S. Application Data
(60) Provisional application No. 63/447,060, filed on Feb. 21, 2023.

(51) Int. Cl. B25J 9/16; B05B 12/14; B25J 9/00; B25J 19/02

(52) U.S. Cl. CPC B25J 9/1679; B05B 12/1409; B25J 9/0093; B25J 9/1666; B25J 9/1697; B25J 19/022

(57) ABSTRACT

A robotic applicator and a coating system and method for real-time control of the application of one or more coatings onto the surface of a substrate. The coatings can include various primer layers, adhesive agents, tinting/coloring agents, and/or chemical solvent layers onto glass substrates. A single robotic applicator can include a pair of applicators to apply different coating layers onto the substrate surface. The overall system and method includes an initial optical vision system, along with a series of optical vision systems, and a series of robotic applicators, that cooperate with a central processing unit to customize the coating sequence and pattern for the particular substrate material, shape, and/or intended use of the coated substrate.

### CROSS-REFERENCE TO RELATED APPLICATION

This application claims the benefit of U.S. Provisional Patent Application No. 63/447,060, filed Feb. 21, 2023.

### BACKGROUND OF THE INVENTION

### Field of the Invention

The present invention relates to a robotic applicator and a coating system and method for real-time control of the application of one or more coatings onto the surface of a substrate, and more particularly, to a robotic applicator and coating system for real-time control and real-time modification of the application of various primer layers, adhesive agents, tinting/coloring agents, and/or chemical solvent layers onto glass substrates.

### Description of Related Art

Glass substrates are often treated or coated with various coatings to achieve certain properties, to allow the fastening of elements thereto, to meet certain safety standards, and/or to allow for the proper cleaning, activation, indication, or adhesion of the components to be integrated into or onto the substrate. The glass substrates are used for buildings, windows, solar cells, and the like, as well as, for automotive windows, such as windshields, medallions, rear windows, sidelites, roofs, sunroofs and other accessories from the glass substrates. One example of a coating applied onto automotive windows is a black, ceramic frit, having a roughened surface that is applied along the marginal edge of the automotive windows to create a blackened area. A clear glass primer is typically applied before the application of the black ceramic frit to assist in the retention of the frit on the surface. These various layers can be applied by hand, by brushes manipulated by robots, or applied by spray nozzles, however, these processes often result in inadequate coating/application of the various layers onto the automotive windows, coating at the wrong location, and/or application of an excess of coatings, resulting in the waste of these expensive materials. The operation of the robot or spray nozzles is typically controlled by an operator followed by an operator-controlled inspection system, which can be labor intensive. Further, these coating systems usually only allow for the application of a specific coating profile onto a specifically shaped substrate.

There is a need in the art for a coating system and methodology for real-time control and real-time modification of the application of coatings onto substrates, such as glass substrates for buildings and for the automotive industry. This system would enable the application of various primer layers, adhesive agents, tinting/coloring agents, chemical solvents, nanoparticles, and the like. There is also a need for an system that allows for comparison and self-correction against a master pattern in real-time, a vision system to verify the position and degrees of rotation of the substrate and to verify the presence, width, and the correct position of the applied coating, resulting in the reduction of the workforce, reduction in the cost of goods, reduction in errors, and the ability to easily customize or modify the coating system based on a particular shape/coating profile.

### SUMMARY OF THE INVENTION

In accordance with one aspect, the present disclosure is directed to a system for applying one or more coatings onto a surface of a substrate comprising a pumping and dispensing system for supplying a coating, at least a first robotic unit associated with the pumping and dispensing system, the first robotic unit having a first applicator including at least a first nozzle and a second applicator including a second nozzle for applying at least a first coating and at least a second coating onto the surface of the substrate. The first robotic unit being movable with respect to the surface of the substrate. At least a first laser system and at least a second laser system are mounted on each of the first applicator and the second applicator for observing the shape of the substrate and for monitoring the application of at least the first coating and the second coating onto the surface of the substrate. A control unit is provided that is configured for cooperating with the first laser system and the second laser system for real-time modification of the movement of the first robotic unit during the application of the coating onto the substrate based on the observed shape of the substrate and for controlling the first applicator and the second applicator to control the application of the first and second coating onto the substrate.

The pumping and dispensing system can be configured for supplying two different coating materials to the first applicator and the second applicator so that two different coatings can be applied onto the surface of the substrate. The first and second laser systems can be configured for observing the amount and/or thickness of coating applied to the surface of the substrate and the control unit can be configured for real-time modification of the amount of coating applied to the surface of the substrate.

According to one embodiment, at least the first laser system can function as a locator sensor for the substrate by generating a search trajectory and comparing the search trajectory against a previously learned master pattern. At least the first laser system can include a first laser sensor configured for generating a real-time three-dimensional image of a coating route for the first robotic applicator and can function as an inspection system that measures the quantity, position, width, and thickness of the coating applied to the substrate.

The control unit can be configured for turning on and off the pumping and dispensing system to determine when at least the first coating and the second coating require replenishment. The dispensing of the first coating and the second coating can be separately controlled.

The system can further include a conveyor for transporting the substrate and can include a series of security scanners located adjacent to the conveyor, wherein a detection of an abnormality with the substrate or a detection of a foreign object within a predetermined safe zone by one or more of the security scanners sends a signal to the control unit to control the movement of the conveyor and/or at least the first robotic applicator.

The control unit can be configured for real-time modification of a speed at which the coating is dispensed from the first nozzle of the first robotic applicator and/or the second nozzle of the second robotic applicator.

The substrate can be a flat or curved glass, such as used for automotive windows, and at least the first robotic applicator is configured for applying various types of coatings, such as a primer, a chemical solvent, an adhesive, and the like.

In accordance with another aspect, the present disclosure is directed to a system for applying one or more coatings onto a surface of a substrate comprising an initial optical vision system for observing the substrate and/or reading a label on the substrate, wherein the optical vision system is located at an entrance of the system. The initial vision system can be associated with a control unit and a data cloud for identifying one or more of a substrate model, shape, size, position, pattern, application variables, a number/type of the coating required, dwell times, activation times, and release times of the coating. The system further includes a conveyor structure for transporting the substrate through the system past one or more processing stations. Each of the one or more processing stations can comprise a pumping and dispensing system for supplying one or more coatings, a robotic unit including at least one applicator having at least a first nozzle for dispensing the one or more coatings onto the surface of the substrate based on data obtained from at least the initial optical vision system. The robotic unit is movable with respect to the surface of the substrate. The processing stations also include a processor optical vision system including at least one laser system for observing the application of the coating onto the substrate. The system also includes a program logic controller configured for cooperating with the control unit, the data cloud, the initial optical vision system, and the one or more processing stations for controlling, in real-time, the application of the coating onto the surface of the substrate.

According to one embodiment, the one or more processing stations comprise a plurality of processing stations for applying a series of different coatings to one or more substrates moving along the conveyor structure. The conveyor structure can include one or more positioning mechanisms located at the one or more processing stations.

The robotic unit can include at least a second applicator having a second nozzle such that the first applicator and second applicator apply at least a first coating and at least a second coating onto the substrate. The processor optical vision system can comprise at least a first laser system and at least a second laser system for observing the shape of the substrate and for monitoring the application of at least the first coating and the second coating onto the surface of the substrate. The processor optical vision system then communicates the monitored information to the control unit.

According to one embodiment, the pumping and dispensing system can be configured for supplying two different coating materials to the first applicator and the second applicator such that two different coatings are applied onto the surface of the substrate. The first laser system and the second laser system are configured for observing the amount and/or thickness of coating applied to the surface of the substrate. The control unit is configured for real-time modification of the amount of coating applied to the surface of the substrate.

The system further includes mobile and angular support bases for the robotic units and the control unit and controller controls the movement of the robotic units.

Either or both of the initial optical vision system and/or the processing optical vision system is capable of identifying a model, type, and/or size of the substrate to be coated. The initial and/or processor optical vision system can be configured for cooperation with the control unit to determine at least one of an application route of the coatings, a number of coatings required, a coating application order, a coating drying time, and a coating activation time, and wherein the controller is capable of real-time modification of the coating.

The system can also include a final optical vision system located at an exit of the system and associated with the control unit for inspection of the application of the coating and for inspection for compliant and non-compliant final products. The final optical vision system can be associated with a marking system that records any required traceability data of at least an applied coating sequence so that the sequence can be consulted in the control unit data to provide a correct traceability of the applied coating sequence.

The system can further include a plurality of sensors for monitoring and controlling the consumption of the coatings used by the one or more processing stations and sending consumption data to the control unit, wherein this data is used to perform a cost analysis of the coatings applied and to optimize the performance of the system.

A series of security scanners can be located adjacent to the conveyor, wherein the detection of an abnormality with the substrate or the detection of a foreign object within a predetermined safe zone by the one or more scanners sends a signal to the control unit to stop the movement of the conveyor and/or the robotic unit.

It can be appreciated that the system of the present disclosure can be used to apply a coating to various types and shapes of substrates. According to one embodiment, the system of the present disclosure can be used to coat a flat or curved glass substrate and the one or more processing stations are configured for applying various coatings such as primers, chemical solvents, adhesive, and the like to the glass substrate.

In accordance with yet another aspect, the present disclosure is directed to a method for real-time modification of an application of one or more coatings onto a surface of a substrate comprising providing an initial optical vision system for observing the substrate located at an entrance of the system, the optical vision system being associated with a control unit and a data cloud for identifying one or more of a substrate model, shape, size, position, pattern, application variables, number/type of the coating required, dwell times, activation times, and release times of the coating. The method further comprises placing the substrate on a conveyor structure and transporting the substrate past the initial optical vision system for observation of the substrate, transporting the substrate past one or more processing stations, and applying one or more coatings to the surface of the substrate. Each of the one or more processing stations comprises a pumping and dispensing system for supplying one or more coatings, a robotic unit associated with the pumping and dispensing system, the robotic unit including at least a first applicator having at least a first nozzle for dispensing at least one of the one or more coatings onto a substrate surface based on data obtained from at least the initial optical vision system, the robotic unit being movable with respect to the substrate surface. The processing stations can also include a processor optical vision system including at least one laser system for observing the application of the coating onto the substrate. The method further comprises providing a program logic controller configured for cooperating with the control unit, the data cloud, the initial optical vision system, and the one or more processing stations for controlling, in real-time, the application of the coating onto the surface of the substrate.

The method can include providing a plurality of processing systems for applying a series of coatings to one or more substrates moving along the conveyor structure. The method can also include providing one or more positioning mechanisms on the conveyor adjacent to each of the processing stations, the one or more positioning mechanisms configured for holding the substrate in place during the application of the coating. The robotic unit includes the first applicator having the first nozzle and can include a second applicator having a second nozzle. The first applicator and the second applicator applies at least the first coating and at least a second coating supplied by the pumping and dispensing system. The processor optical vision system can comprise at least a first laser system and at least a second laser system for observing the shape of the substrate and for monitoring the application of at least the first coating and the second coating onto the surface of the substrate. The processor optical vision system communicates the monitored information to the control unit.

The pumping and dispensing system can supply two different coating materials to the first applicator and the second applicator such that two different coatings are applied onto the surface of the substrate. The first laser system and the second laser system can observe the amount and/or thickness of coating applied to the surface of the substrate and the control unit is configured for real-time modification of the amount of coating applied to the surface of the substrate.

The method can further comprise providing a plurality of sensors for monitoring and controlling a consumption of the coatings used by the one or more processing stations and sending consumption data to the control unit, and wherein this data is used to perform a cost analysis of the coatings applied and to optimize the performance of the system. The method can also comprise providing a series of security scanners adjacent to the conveyor for detecting any abnormalities with the substrate or for detecting the presence of a foreign object within a predetermined safe zone, and wherein the one or more scanners sends a signal to the control unit to stop the movement of the conveyor and/or the robotic unit. It can be appreciated that the method of coating can be used to apply one or more coatings to any substrate. According to one embodiment, the substrate can comprise a flat or curved glass substrate and the one or more processing stations can be configured to apply various coatings, such as a primer, chemical solvents, adhesive, and the like.

Additional embodiments or aspects of the robotic applicator and coating system and method are detailed in one or more of the following clauses.

Clause 1: A system for applying one or more coatings onto a surface of a substrate comprising: (a) a pumping and dispensing system for supplying a coating; (b) at least a first robotic unit associated with the pumping and dispensing system, the first robotic unit including a first applicator having at least a first nozzle and a second applicator having at least a second nozzle for applying at least a first coating and at least a second coating onto the surface of the substrate, said first robotic unit being movable with respect to the surface of the substrate; (c) at least a first laser system and at least a second laser system mounted on the first robotic unit for observing a shape of the substrate and for monitoring application of at least the first coating and the second coating onto the surface of the substrate; and (d) a control unit configured for cooperating with the first laser system and the second laser system for real-time modification of movement of the first robotic unit during the application of the coating onto the substrate based on the observed shape of the substrate and for controlling the first applicator and the second applicator to control application of the first and second coating onto the substrate.

Clause 2: The system of clause 1, wherein the pumping and dispensing system is configured for supplying two different coating materials to the first applicator and the second applicator so that two different coatings are applied onto the surface of the substrate.

Clause 3: The system of clause 1 or 2, wherein the first and second laser systems are configured for observing an amount and/or thickness of coating applied to the surface of the substrate and wherein the control unit is configured for real-time modification of the amount of coating applied to the surface of the substrate.

Clause 4: The system of any of clauses 1-3, wherein at least the first laser system functions as a locator sensor for the substrate by generating a search trajectory and comparing the search trajectory against a previously learned master pattern.

Clause 5: The system of any of clauses 1-4, wherein at least the first laser system includes a first laser sensor configured for generating a real-time three-dimensional image of a coating route for the first robotic applicator and to function as an inspection system that measures the quantity, position, width, and thickness of the coating applied to the substrate.

Clause 6: The system of any of clauses 1-6, wherein the control unit is configured for controlling the pumping and dispensing system to determine when at least the first coating and the second coating require replenishment.

Clause 7: The system of any of clauses 1-6, including a conveyor for transporting the substrate and a series of security scanners located adjacent to the conveyor, wherein a detection of an abnormality with the substrate or a detection of a foreign object within a predetermined safe zone by one or more of the security scanners sends a signal to the control unit to control the movement of the conveyor and/or at least the first robotic applicator.

Clause 8: The system of any of clauses 1-7, wherein the control unit is configured for real-time modification of a speed at which the coating is dispensed from the first nozzle and/or the second nozzle.

Clause 9: The system of any of clauses 1-8, wherein the substrate is a flat or curved glass substrate and at least the first robotic applicator is configured for applying a coating comprising at least one of a primer, a chemical solvent, and an adhesive.

Clause 10: A system for applying one or more coatings onto a surface of a substrate comprising: (a) an initial optical vision system for observing the substrate located at an entrance of the system, the initial optical vision system being associated with a control unit and a data cloud for identifying one or more of a substrate model, shape, size, position, pattern, application variables, number/type of the coating required, dwell times, activation times, and release times of the coating; (b) a conveyor structure for transporting the substrate through the system past one or more processing stations, each of the one or more processing stations comprising: (i) a pumping and dispensing system for supplying at least one coating; (ii) a robotic unit associated with a pumping and dispensing system, the robotic unit including at least a first applicator having at least a first nozzle for dispensing at least a first coating onto the surface of the substrate based on data obtained from at least the initial optical vision system, the robotic unit being movable with respect to the surface of the substrate; and (iii) a processor optical vision system including at least a one laser system for observing the application of the coating onto the substrate; and (c) a program logic controller configured for cooperating with the control unit, the data cloud, the initial optical vision system, and the one or more processing stations for controlling, in real-time, the application of the one or more coatings onto the surface of the substrate.

Clause 11: The system of clause 10, wherein the one or more processing stations comprises a plurality of processing stations for applying a series of different coatings to one or more substrates moving along the conveyor structure.

Clause 12: The system of clause 10 or 11, wherein the conveyor structure includes one or more positioning mechanisms located at the one or more processing stations.

Clause 13: The system of any of clauses 10-12, wherein the robotic unit includes the first applicator for applying the first coating and at least a second applicator having at least a second nozzle for applying at least a second coating and wherein the processor optical vision system comprises at least a first laser system and at least a second laser system for observing a shape of the substrate and for monitoring application of the first coating and the second coating onto the surface of the substrate and wherein the processor optical vision system communicates the monitored information to the control unit.

Clause 14: The system of any of clauses 10-13, wherein the pumping and dispensing system is configured for supplying two different coating materials to the first applicator and the second applicator such that two different coatings are applied onto the surface of the substrate.

Clause 15: The system of clause 14, wherein the first laser system and the second laser system are configured for observing an amount and/or thickness of coating applied to the surface of the substrate, and wherein the control unit is configured for real-time modification of the amount of coating applied to the surface of the substrate.

Clause 16: The system of any of clauses 10-15 including mobile and angular support bases for the robotic unit, and wherein the control unit and controller control movement of the robotic unit.

Clause 17: The system of any of clauses 10-16, wherein at least one of the initial optical vision system and the processing optical vision system is capable of identifying a model, type, and/or size of the substrate to be coated, and wherein the optical vision system is configured for cooperation with the control unit to determine at least one of an application route of the coatings, a number of coatings required, a coating application order, a coating drying time, and a coating activation time, and wherein the controller is capable of real-time modification of the coating.

Clause 18: The system of any of clauses 10-17, including a final optical vision system located at an exit of the system and associated with the control unit for inspection of the application of the coating and for inspection for compliant and non-compliant final products.

Clause 19: The system of clause 18, wherein the final optical vision system is associated with a marking system that records any required traceability data of at least an applied coating sequence so that the sequence can be consulted in the control unit data to provide a correct traceability of the applied coating sequence.

Clause 20: The system of any of clauses 10-19 including a plurality of sensors for monitoring and controlling the consumption of the coatings used by the one or more processing stations and sending consumption data to the control unit, and wherein this data is used to perform a cost analysis of the coatings applied and to optimize the performance of the system.

Clause 21: The system of any of clauses 10-20 including a series of security scanners located adjacent to the conveyor, wherein a detection of an abnormality with the substrate or a detection of a foreign object within a predetermined safe zone by the one or more scanners sends a signal to the control unit to stop the movement of the conveyor and/or the robotic unit.

Clause 22: The system of any of clauses 10-21, wherein the system is configured for coating a flat or curved glass substrate, and the one or more processing stations are configured for applying at least one of a primer, a chemical solvent, and an adhesive.

Clause 23: A method for real-time modification of an application of one or more coatings onto a surface of a substrate comprising: (a) providing an initial optical vision system for observing the substrate located at an entrance of the system, the initial optical vision system being associated with a control unit and a data cloud for identifying one or more of a substrate model, shape, size, position, pattern, application variables, number/type of the coating required, dwell times, activation times, and release times of the coating; (b) placing the substrate on a conveyor structure and transporting the substrate past the initial optical vision system for observation of the substrate; (c) transporting the substrate past one or more processing stations and applying one or more coatings to the surface of the substrate, each of the one or more processing stations comprising: (i) a pumping and dispensing system for supplying at least one coating; (ii) a robotic unit associated with the pumping and dispensing system, the robotic unit including at least a first applicator having at least a first nozzle for dispensing at least a first coating onto the surface of the substrate based on data obtained from at least the initial optical vision system, the robotic unit being movable with respect to the substrate surface; and (iii) a processor optical vision system including at least one laser system for observing the application of the coating onto the substrate; and (d) providing a program logic controller configured for cooperating with the control unit, the data cloud, the initial optical vision system, and the one or more processing stations for controlling, in real-time, the application of the coating onto the surface of the substrate.

Clause 24: The method of clause 23, comprising providing a plurality of processing systems for applying a series of coatings to one or more substrates moving along the conveyor structure.

Clause 25: The method of clause 23 or 24, comprising providing one or more positioning mechanisms on the conveyor adjacent to each of the processing stations, the one or more positioning mechanisms configured for holding the substrate in place during the application of the coating.

Clause 26: The method of any of clauses 23-25, wherein the robotic unit includes at least the first applicator and a second applicator having at least a second nozzle, the first applicator and second applicator configured for applying at least a first coating, and at least a second coating and wherein the processor optical vision system comprises at least a first laser system and at least a second laser system for observing a shape of the substrate and for monitoring application of at least the first coating and the second coating onto the surface of the substrate and wherein the processor optical vision system communicates the monitored information to the control unit.

Clause 27: The method of clause 26, wherein the pumping and dispensing system supplies two different coating materials to the first applicator and the second applicator such that two different coatings are applied onto the surface of the substrate.

Clause 28: The method of clause 26, wherein the first laser system and the second laser system observe an amount and/or thickness of coating applied to the surface of the substrate and wherein the control unit is configured for real-time modification of the amount of coating applied to the surface of the substrate.

Clause 29: The method of any of clauses 23-28, comprising providing a plurality of sensors for monitoring and controlling a consumption of the coatings used by the one or more processing stations and for sending consumption data to the control unit, and wherein this data is used to perform a cost analysis of the coatings applied and to optimize the performance of the system.

Clause 30: The method of any of clauses claim 23-29, comprising providing a series of security scanners adjacent to the conveyor for detecting any abnormalities with the substrate or for detecting the presence of a foreign object within a predetermined safe zone, and wherein the one or more of the scanners sends a signal to the control unit to stop movement of the conveyor and/or the robotic unit.

Clause 31: The method of any of clauses 23-30, wherein the substrate comprises a flat or curved glass substrate and the one or more processing stations are configured for applying at least one of a primer, a chemical solvent, and an adhesive.

### BRIEF DESCRIPTION OF THE DRAWINGS

The above-mentioned and other features and advantages of this disclosure, and the manner of attaining them, will become more apparent and the disclosure itself will be better understood by reference to the following descriptions of embodiments of the disclosure taken in conjunction with the accompanying drawings. Unless indicated to the contrary, the drawing figures are not to scale.

FIG. 1A is a perspective back view of a robotic coating applicator in accordance with an embodiment of the present invention.

FIG. 1B is a perspective front view of the robotic coating applicator of FIG. 1A in accordance with an embodiment of the invention.

FIG. 2A is a back view of the robotic coating applicator of FIGS. 1A and 1B in accordance with an embodiment of the invention.

FIG. 2B is a side view of the robotic coating applicator of FIGS. 1A and 1B in accordance with an embodiment of the invention.

FIG. 2C is a front view of the robotic coating applicator of FIGS. 1A and 1B in accordance with an embodiment of the invention.

FIG. 3A is a top view of the robotic coating applicator of FIGS. 1A and 1B in accordance with an embodiment of the invention.

FIG. 3B is a bottom view of the robotic coating applicator of FIGS. 1A and 1B in accordance with an embodiment of the invention.

FIG. 4 is a front perspective view of a coating system using a series of the robotic coating applicator of FIGS. 1A and 1B in accordance with an embodiment of the invention.

FIG. 5A is a front view of the coating system of FIG. 4 in accordance with an embodiment of the invention.

FIG. 5B is a top view of the coating system of FIG. 4 in accordance with an embodiment of the invention.

FIG. 6 is an overall coating system for real-time control and real-time modification of the application of various coating layers to a substrate in accordance with an embodiment of the invention.

FIGS. 7A-7D show various shaped substrates that can be coated with the coating system of FIG. 4 and/or FIG. 6 in accordance with an embodiment of the invention.

The above-mentioned and other features and advantages of this disclosure, and the manner of attaining them, will become more apparent and the disclosure itself will be better understood by reference to the following descriptions of embodiments of the disclosure taken in conjunction with the accompanying drawings.

### DESCRIPTION OF THE INVENTION

As used herein, spatial or directional terms, such as “left”, “right”, “inner”, “outer”, “above”, “below”, and the like, relate to the invention as it is shown in the drawing figures. However, it is to be understood that the invention can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims may vary depending upon the desired properties sought to be obtained by the present invention. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. Additionally, all documents, such as but not limited to, issued patents and patent applications, referred to herein are to be considered to be “incorporated by reference” in their entirety.

All documents referred to herein are to be considered to be “incorporated by reference” in their entirety.

The discussion of the invention herein may describe certain features as being “particularly” or “preferably” within certain limitations (e.g., “preferably”, “more preferably”, or “even more preferably”, within certain limitations). It is to be understood that the invention is not limited to these particular or preferred limitations but encompasses the entire scope of the disclosure.

As used herein, the transitional term “comprising” (and other comparable terms, e.g., “containing” and “including”) is “open-ended” and open to the inclusion of unspecified matter. Although described in terms of “comprising”, the terms “consisting essentially of” and “consisting of” are also within the scope of this disclosure.

The invention comprises, consists of, or consists essentially of, the following aspects of the invention, in any combination. Various aspects of the invention are illustrated in separate drawing figures. However, it is to be understood that this is simply for ease of illustration and discussion. In the practice of the invention, one or more aspects of the invention shown in one drawing figure can be combined with one or more aspects of the invention shown in one or more of the other drawing figures.

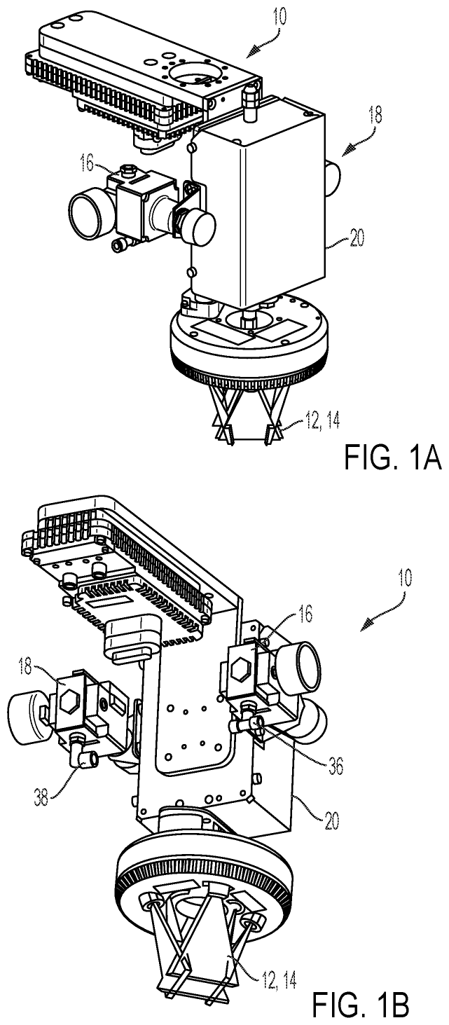

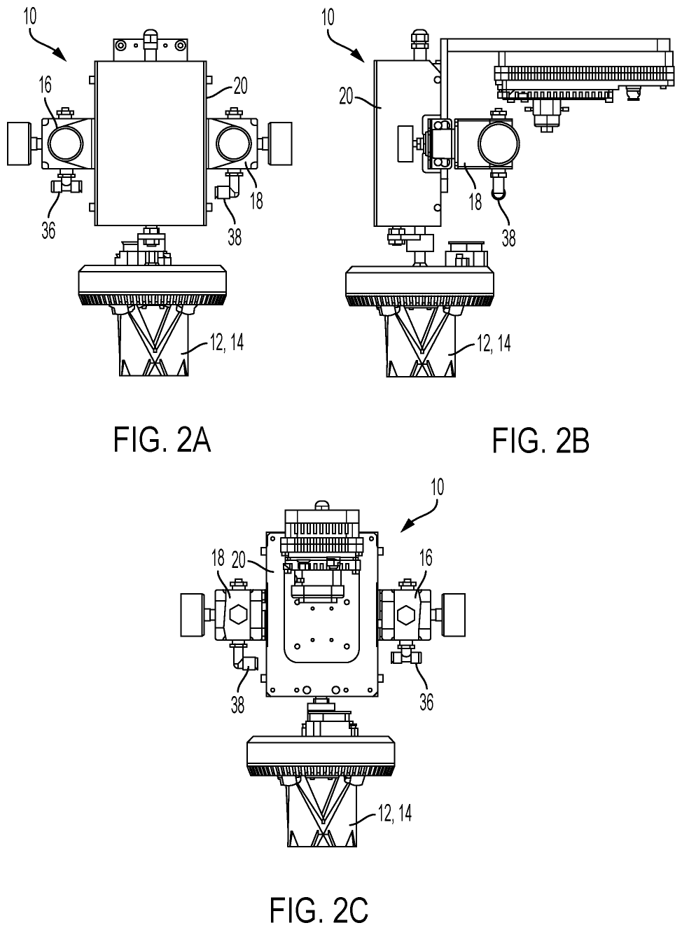

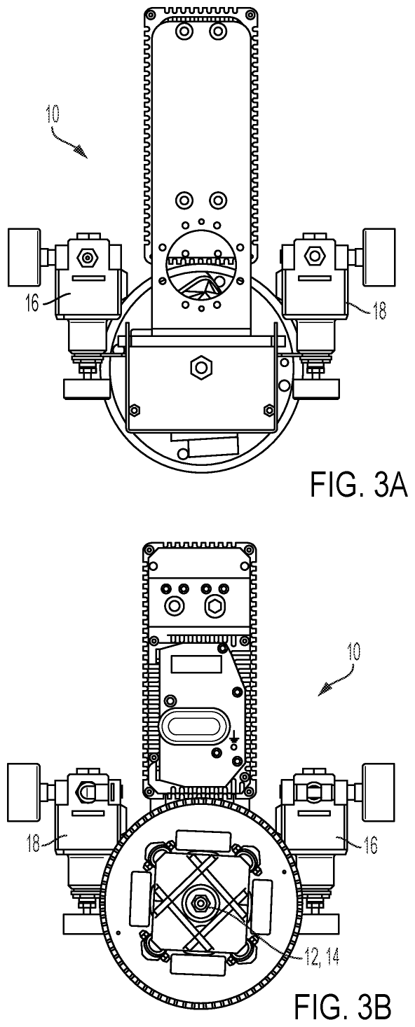

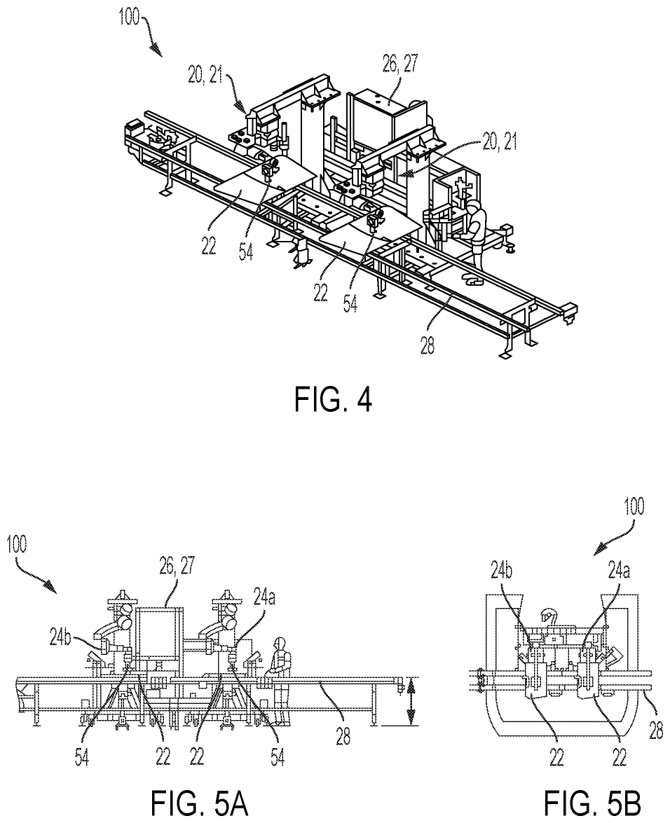

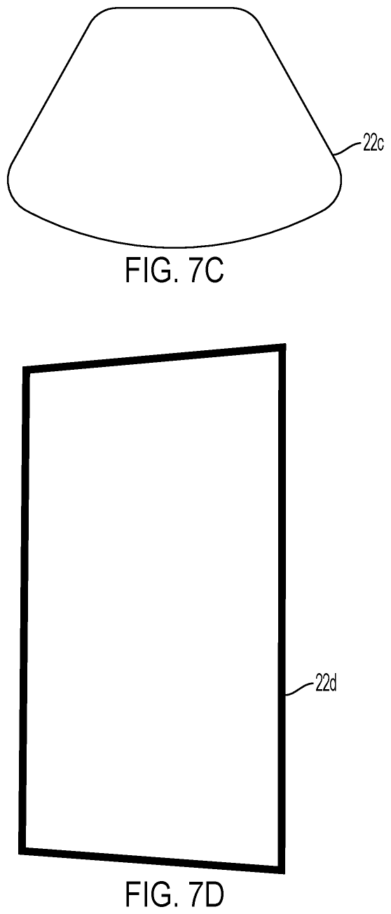

Reference is now made to FIGS. 1A-1B, FIGS. 2A-2C, and FIGS. 3A-3B, which show various views of a robotic coating applicator, generally indicated as 10, in accordance with an embodiment of the present invention. Referring now to FIGS. 4, 5A-5B and FIG. 6, the robotic coating applicator 10 can comprise a first applicator 10a that is mounted on a first robotic unit 24a. The first applicator 10a includes at least a first nozzle 12 for applying at least a first coating. A second applicator 10b can be provided on the first robotic unit 24a, wherein the second applicator 10b includes a second nozzle 14 for applying at least a second coating. The first and second coatings can be supplied from a pumping 20 and dispensing system 21, onto the surface of the substrate 22. The substrate 22 can include any known substrate, including glass, plastic, or multi-layer substrates used for buildings, windows, solar cells, and the like, as well as glass substrates used for automotive windows, such as windshields, medallions, rear windows, sidelites, roofs, sunroofs and other accessories from the glass substrates. It can be appreciated that the substrate 22 can be curved or flat and can have various shapes 22a-22d, examples of which are shown in FIGS. 7A-7D.

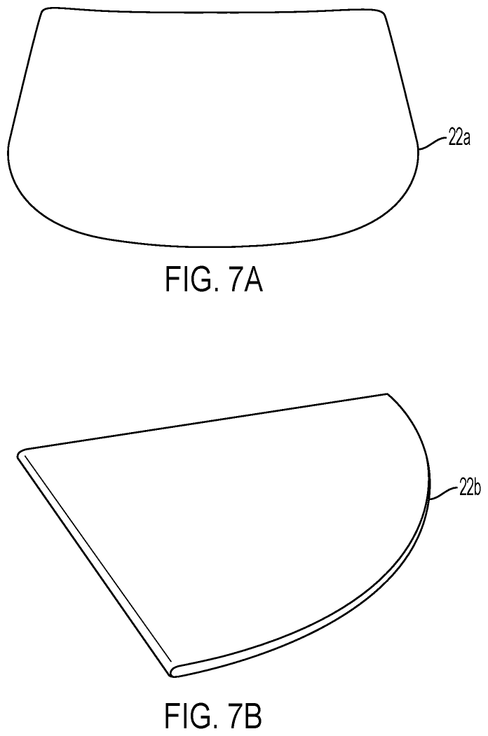

The first robotic unit 24a is movable with respect to the surface of the substrate 22. According to one embodiment, the first robotic unit 24a can include at least two 90° angled structures (BASE 90°) 25, as shown in FIG. 6, that rigidly support the first robotic unit 24a. The coatings can comprise any well-known coating materials such as one or more various primer layers, adhesive agents, tinting/coloring agents, chemical solvents, nanoparticles, and the like.

Referring back to FIGS. 1A-1B, FIGS. 2A-2C, and FIGS. 3A-3B, at least a first laser system 16 and at least a second laser system 18 is mounted on each of the first applicator 10a and second applicator 10b for observing a shape of the substrate 22 and for monitoring the application of at least the first coating and/or the second coating onto the surface of the substrate 22. A control unit 26, along with a programmable logic controller 27, shown in FIGS. 4, 5A, and 6, cooperate with the first laser system 16 and the second laser system 18 to effect real-time modification of the movement of the first robotic unit 24a during the application of the coatings onto the substrate 22 based on the observed shape of the substrate 22 and for controlling the first nozzle 12 and the second nozzle 14 to control the application of the first and second coatings onto the substrate 22.

The pumping and dispensing systems 20, 21 can be configured for supplying different coating materials to the first nozzle 12 and the second nozzle 14 so that different coatings can be applied onto the surface of the substrate 22 using a single robotic unit 24a. The first and second laser systems 16, 18 can be configured for observing an amount and/or thickness of coating applied to the surface of the substrate 22. The control unit 26 is configured for real-time modification of the amount of coating applied to the surface of the substrate 22.

According to one embodiment, at least the first laser system 16 can function as a locator sensor for observing the substrate 22 and for generating a search trajectory and comparing the search trajectory against a previously learned master pattern. At least the first laser system 16 can include a first laser sensor 36 configured for generating a real-time three-dimensional image of a coating route for at least the first robotic unit 24a for application of the first coating by the first applicator 10a. This first laser system 16, along with the second laser system 18, having a second laser sensor 38 can function as an inspection system that measures the quantity, position, width, and thickness of the coating applied to the substrate 22. A similar two-part laser system can be associated with the second robotic applicator 10b. The laser systems associated with the first and second applicators 10a, 10b function to control the movement of the first robotic unit 24a.

It can be appreciated that the control unit 26 can also be configured for monitoring the pumping and dispensing systems 20, 21 to determine when at least the first coating and the second coating require replenishment. The control unit 26 can separately control the pumping and dispensing systems 20, 21 wherein it can separately turn on and separately turn off the application of a first coating or the second coating.

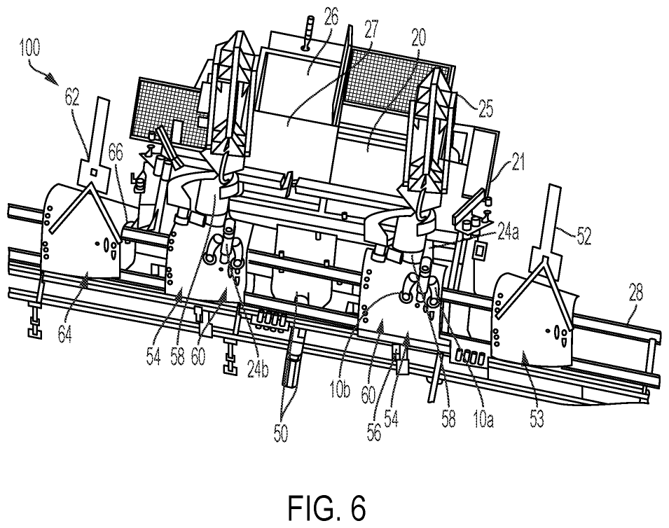

The system can further include a conveyor 28 for transporting the substrate 22 or a series of substrates “22n”, where “n” represents any number of items. It can be appreciated that at least a second robotic unit 24b, shown in FIGS. 5A and 6, can be provided, wherein the second robotic unit 24b also includes first and second applicators 10a, 10b, as described above. It can further be appreciated that a series of robotic units “24n”, including a series of applicators “10n”, can be provided along the conveyor 28 to apply a series of coatings onto the substrate 22. As discussed above in relation to the first robotic unit 24a, the second robotic unit 24b or a series of robotic units, are movable with respect to the substrate 22. The conveyor 28 can include a series of security scanners/sensors 50, shown in FIG. 6, located adjacent to the conveyor 28, wherein a detection of an abnormality with the substrate 22 or a detection of a foreign object within a predetermined safe zone by one or more of the security scanners sends a signal to the control unit 26 to control the movement of the conveyor 28 and/or at least the first robotic applicator 10a.

The control unit 26 can be configured for real-time modification of a speed at which the coating is dispensed from the first nozzle 12 and/or second nozzle 14 of the robotic applicators 10a, 10b.

Reference is now made to FIG. 6 which illustrates an overall system 100 for the application of chemical solvents on substrates, such as glass substrates for use in both flat and automotive applications. The system includes a conveyor 28, which can be in the form of a servo-motorized chain whose purpose is to transport the glass substrate to various processing stations (ST1, ST2, STN, STF) 53, 54, 64. An initial optical vision system (SOV1) 52 is provided at the initial processing station 53, (ST1) to identify the model, type, size, application route, number of chemical solvents required, application order, drying time, activation time, inspection of correct application, and inspection of a compliant or non-compliant product. According to one design, the initial optical vision system 52 can be designed to read printed information/optical indicium that is located on a label secured to the substrate or printed directly on the substrate itself. This optical indicium may include at least one of: a one-dimensional barcode, a two-dimensional barcode, printed symbols, (e.g., text, numbers, and/or non-alphanumeric symbols), one or more dimensions or shape of the substrate (e.g., a width, length, thickness, shape, etc.), a color tag, a label or model number, and/or the like, that provides at least some or all of this information. The initial optical vision system 52 is connected to a central processing unit (CPU) 26 and data cloud for the recognition of substrate shape, position, and pattern, as well as application variables such as contours, curvatures, number of chemical solvents required, dwell times, activation times, and release times.

The system includes one or more sensors (SSEC) 50 for industrial safety, which can be programmed to detect safe zone, preventive zone, and total stop zone due to the invasion of any object or person within the assigned work area.

According to one embodiment, the system can be used for applying chemical solvents to a plurality of substrates 22 in application stages. The servo motorized conveyor 28 places the flat or automotive-type glass substrate at processing station (ST2) 54, where a servo-pneumatic clamping system or positioning mechanism (MPO) 56 will provide the support and force required to keep the glass substrate 22 in position to enable the robotic coating applicator 10 to scan, apply the coating, and inspect each application of the coating to ensure that such coating application is in compliance with the application pattern, quantity, and time of application.

As discussed above, the system comprises chemical solvent pumping systems (SBOMB) 20 controlled by means of a programmable logic system 26, 27 which controls the pressure and flow of the chemical, these values change depending on the algorithm of the data obtained from the central processing unit 26 and the data cloud. The overall system includes coating applicators (AP1, 2 . . . n) 10a, 10b . . . 10n, as discussed above, which allow for the proper application of a series of coatings on the substrates 22. These applicators 10a, 10b can be replaced by the robotic system (SR1) 58, by the sequence of use, wear, or change of product.

With continuing reference to FIG. 6, the system includes applicator dispensing elements (EXAP) 21 in types and shapes required to meet the programmed needs depending directly on the type of glass substrate to be processed, flat or automotive application. Overall optical-vision systems (SOV2, SOV3) 60 including lasers 16, 18, as discussed above, are mounted on the first and second applicators 10a, 10b to check the position of the substrate to determine the initial process area, previously checking by means of data exchange from the central processing unit, 26 programmable logic control 27, and data cloud. The system is designed to initiate the application of the coatings (chemical, solvents, and the like) by means of the defined and required applicators (AP1, AP2) 10a, 10b in different areas and profile of the substrate 22, wherein the processor optical-vision system (SOV2, SOV3) 60 mounted together with the applicators 10a, 10b will check in real-time if the pattern applied is effectively applied in accordance with the data load previously obtained in the database of patterns and chemicals extracted from the central processing unit 26, programmable logic control 27, and data cloud. According to one embodiment, the processor optical-vision system (SOV2, SOV3) 60 will send the data obtained in real-time to be compared in the central processing unit 26, which will issue follow-up orders on the application pattern, in the event that any area is left without the correct application of the chemical. The system will receive instructions from the central processing unit 26 to create a programmable logic system application routine in the area or profile where the incorrect application occurred. This data will be sent back to the central processing unit 26 and the data cloud to obtain metrics in the process control. During its validation stage, the optical-vision system will check by means of the comparison of patterns its validity or invalidity in the final optical vision system (SOVF) 62 and a final processing station (STF) 54, and registering in the programmable logic control 27 and at the same time in the central processing unit 26 and data cloud. This data will be obtained by a marking system (SMSG) 66 that will record the required traceability data of at least the applied sequence so that it can be easily consulted in the system data and thus provide a correct traceability process of the application of chemical solvents on the processed substrate 22.

Now referring to FIGS. 5A-5B and with continuing reference to FIG. 6, the present disclosure is directed to a method for real-time modification of an application of one or more coatings onto a surface of a substrate 22 comprising providing an initial optical vision system 52 for observing the substrate 22 located at an entrance of the system 100. The initial optical vision system 52 is associated with a control unit 26 and a data cloud for identifying one or more of a substrate model, shape, size, position, pattern, as well as application variables such as number/type of the coating required, dwell times, activation times, and release times of the coating. The method further comprises placing the substrate 22 on the conveyor structure 28 and transporting the substrate 22 past the initial optical vision system 52 for observation of the substrate 22, transporting the substrate 22 past one or more processing stations 54, and applying one or more coatings to the surface of the substrate 22. Each of the one or more processing stations 54 comprises a pumping and dispensing system 20, 21 for supplying one or more coatings, and a robotic unit 24 associated with the pumping and dispensing systems 20, 21. The robotic unit 24 includes at least a first applicator 10a having at least a first nozzle 12 for dispensing at least one of the one or more coatings onto a substrate 22 surface based on data obtained from at least the initial optical vision system 52. The robotic unit 24 is movable with respect to the substrate 22 surface. The processing stations 54 can also include a processor optical vision system 60 including at least one laser system 16, 18 for observing the application of the coating onto the substrate 22 surface. The method further comprises providing a program logic controller 27 configured for cooperating with the control unit 26, the data cloud, the initial optical vision system 52, and the one or more processing stations 54 for controlling, in real-time, the application of the coating onto the surface of the substrate 22.

The method can include providing a plurality of processing systems or stations 54 for applying a series of coatings to one or more substrates 22 moving along the conveyor structure 28. The method can also include providing one or more clamping systems or positioning mechanisms 56 on the conveyor adjacent to each of the processing stations 54, the one or more positioning mechanisms 56 configured for holding the substrate 22 in place during the application of the coating. The robotic unit 24 includes the first applicator 10a having the first nozzle 12 and can include a second applicator 10b having a second nozzle 14. The first applicator 10a and the second applicator 10b apply at least the first coating and at least a second coating supplied by the pumping and dispensing systems 20, 21. The processor optical vision system 60 can comprise at least a first laser system 16 and at least a second laser system 18 for observing a shape of the substrate 22 and for monitoring the application of at least the first coating and the second coating onto the surface of the substrate 22. The processor optical vision system 60 communicates the monitored information to the control unit 26.

The pumping and dispensing systems 20, 21 can supply two different coating materials to the first applicator 10a and the second applicator 10b such that two different coatings are applied onto the surface of the substrate 22. The first laser system 16 and the second laser system 18 can observe an amount and/or thickness of coating applied to the surface of the substrate 22 and the control unit 26 is configured for real-time modification of the amount of coating applied to the surface of the substrate.

The method can further comprise providing a plurality of sensors 36, 38 for monitoring and controlling a consumption of the coatings used by the one or more processing stations 54 and sending consumption data to the control unit 26. This data can be used to perform a cost analysis of the coatings applied and to optimize the performance of the system. The method can also comprise providing a series of security scanners 50 adjacent to the conveyor 28 for detecting any abnormalities with the substrate 22 or for detecting the presence of a foreign object within a predetermined safe zone. The one or more of the scanners 50 can send a signal to the control unit 26 and programmable logic controller 27 to stop the movement of the conveyor 28 and/or the robotic unit 24. It can be appreciated that the method of coating can be used to apply one or more coatings to any substrate. With reference to FIGS. 7A-7D, the substrate 22a-22d can comprise a flat or curved glass substrate and the one or more processing stations 54 be configured to apply various coatings, such as a primer, chemical solvents, adhesive, and the like.

The method and system of the present invention is capable of monitoring and controlling the consumption of chemical solvents used at each of the processing stations 54, as well as totalizing consumption data, sending the consumption data to the central processing unit 26 and the data cloud, to totalize raw material consumption and the costs incurred in the processes. This same data can be used for statistical multi-varied studies that improve the performance of the system algorithm and improves the method for applying chemical solvents to the substrates 22.

The system of the present invention allows for continuous and constant production flexibility, and the continuous processing of different models and requirements without the need to continuously change recipes in the system.

The system also allows for the rational use of chemical solvents, applying the necessary amount and trace, improving the consumption of raw materials of solvent chemicals and applicators used in the process.

While the disclosure has been described as having exemplary designs, the present disclosure can be further modified within the spirit and scope of this disclosure. This application is, therefore, intended to cover any variations, uses, or adaptations of the disclosure using its general principles. Further, this application is intended to cover such departures from the present disclosure as come within the known or customary practice in the art to which this disclosure pertains and which falls within the limits of the appended claims.

The invention claimed is:

1. A system for applying one or more coatings onto a surface of a substrate comprising:
a. a pumping and dispensing system for supplying a coating;
b. at least a first robotic unit associated with the pumping and dispensing system, the first robotic unit including a first applicator having at least a first nozzle and a second applicator having at least a second nozzle for applying at least a first coating and at least a second coating onto the surface of the substrate, said first robotic unit being movable with respect to the surface of the substrate;
c. at least a first laser system and at least a second laser system mounted on the first robotic unit for observing a shape of the substrate and for monitoring application of at least the first coating and the second coating onto the surface of the substrate; and
d. a control unit configured for cooperating with the first laser system and the second laser system for real-time modification of movement of the first robotic unit during the application of the coating onto the substrate based on the observed shape of the substrate and for controlling the first applicator and the second applicator to control application of the first and second coating onto the substrate.

2. The system of claim 1, wherein the pumping and dispensing system is configured for supplying two different coating materials to the first applicator and the second applicator so that two different coatings are applied onto the surface of the substrate.

3. The system of claim 1, wherein the first and second laser systems are configured for observing an amount and/or thickness of coating applied to the surface of the substrate and wherein the control unit is configured for real-time modification of the amount of coating applied to the surface of the substrate.

4. The system of claim 1, wherein at least the first laser system functions as a locator sensor for the substrate by generating a search trajectory and comparing the search trajectory against a previously learned master pattern.

5. The system of claim 4, wherein at least the first laser system includes a first laser sensor configured for generating a real-time three-dimensional image of a coating route for the first robotic applicator and to function as an inspection system that measures the quantity, position, width, and thickness of the coating applied to the substrate.

6. The system of claim 1, wherein the control unit is configured for monitoring the pumping and dispensing system to determine when at least the first coating and the second coating require replenishment and the control unit is configured for real-time modification of a speed at which the coating is dispensed from the first nozzle and/or the second nozzle.

7. The system of claim 1, including a conveyor for transporting the substrate and a series of security scanners located adjacent to the conveyor, wherein a detection of an abnormality with the substrate or a detection of a foreign object within a predetermined safe zone by one or more of the security scanners sends a signal to the control unit to control the movement of the conveyor and/or at least the first robotic applicator.

8. The system of claim 1, wherein the substrate is a flat or curved glass substrate and at least the first robotic applicator is configured for applying a coating comprising at least one of a primer, a chemical solvent, and an adhesive.

9. A system for applying one or more coatings onto a surface of a substrate comprising:
a. an initial optical vision system for observing the substrate located at an entrance of the system, the initial optical vision system being associated with a control unit and a data cloud for identifying one or more of a substrate model, shape, size, position, pattern, application variables, number/type of the coating required, dwell times, activation times, and release times of the coating;
b. a conveyor structure for transporting the substrate through the system past one or more processing stations, each of the one or more processing stations comprising:
(i) a pumping and dispensing system for supplying at least one coating;
(ii) a robotic unit associated with the pumping and dispensing system, the robotic unit including at least a first applicator having at least a first nozzle for dispensing at least a first coating onto the surface of the substrate based on data obtained from at least the initial optical vision system, the robotic unit being movable with respect to the surface of the substrate; and
(iii) a processor optical vision system including at least a one laser system for observing the application of the coating onto the substrate; and
c. a program logic controller configured for cooperating with the control unit, the data cloud, the initial optical vision system, and the one or more processing stations for controlling, in real-time, the application of the one or more coatings onto the surface of the substrate.

10. The system of claim 9, wherein the one or more processing stations comprises a plurality of processing stations for applying a series of different coatings to one or more substrates moving along the conveyor structure and wherein the conveyor structure includes one or more positioning mechanisms located at the one or more processing stations.

11. The system of claim 9, wherein the robotic unit includes the first applicator for applying the first coating and at least a second applicator having at least a second nozzle for applying at least a second coating and wherein the processor optical vision system comprises at least a first laser system and at least a second laser system for observing a shape of the substrate and for monitoring application of the first coating and the second coating onto the surface of the substrate and wherein the processor optical vision system communicates the monitored information to the control unit.

12. The system of claim 11, wherein the pumping and dispensing system is configured for supplying two different coating materials to the first applicator and the second applicator such that two different coatings are applied onto the surface of the substrate.

13. The system of claim 11, wherein the first laser system and the second laser system are configured for observing an amount and/or thickness of coating applied to the surface of the substrate, and wherein the control unit is configured for real-time modification of the amount of coating applied to the surface of the substrate.

14. The system of claim 9 including mobile and angular support bases for the robotic unit, and wherein the control unit and controller control movement of the robotic unit.

15. The system of claim 9, wherein at least one of the initial optical vision system and the processing optical vision system is capable of identifying a model, type, and/or size of the substrate to be coated, and wherein the optical vision system is configured for cooperation with the control unit to determine at least one of an application route of the coatings, a number of coatings required, a coating application order, a coating drying time, and a coating activation time, and wherein the controller is capable of real-time modification of the coating.

16. The system of claim 9, including a final optical vision system located at an exit of the system and associated with the control unit for inspection of the application of the coating and for inspection for compliant and non-compliant final products, and wherein the final optical vision system is associated with a marking system that records any required traceability data of at least an applied coating sequence so that the sequence can be consulted in the control unit data to provide a correct traceability of the applied coating sequence.

17. The system of claim 9 including a plurality of sensors for monitoring and controlling the consumption of the coatings used by the one or more processing stations and sending consumption data to the control unit, and wherein this data is used to perform a cost analysis of the coatings applied and to optimize the performance of the system.

18. The system of claim 9 including a series of security scanners located adjacent to the conveyor, wherein a detection of an abnormality with the substrate or a detection of a foreign object within a predetermined safe zone by the one or more scanners sends a signal to the control unit to stop the movement of the conveyor and/or the robotic unit.

19. The system of claim 9, wherein the system is configured for coating a flat or curved glass substrate, and the one or more processing stations are configured for applying at least one of a primer, a chemical solvent, and an adhesive.

20. A method for real-time modification of an application of one or more coatings onto a surface of a substrate comprising:
a. providing an initial optical vision system for observing the substrate located at an entrance of the system, the initial optical vision system being associated with a control unit and a data cloud for identifying one or more of a substrate model, shape, size, position, pattern, and application variables comprising number/type of the coating required, dwell times, activation times, and release times of the coating
b. placing the substrate on a conveyor structure and transporting the substrate past the initial optical vision system for observation of the substrate;
c. transporting the substrate past one or more processing stations and applying one or more coatings to the surface of the substrate, each of the one or more processing stations comprising:
(i) a pumping and dispensing system for supplying at least one coating;
(ii) a robotic unit associated with the pumping and dispensing system, the robotic unit including at least a first applicator having at least a first nozzle for dispensing at least a first coating onto the surface of the substrate based on data obtained from at least the initial optical vision system, the robotic unit being movable with respect to the substrate surface; and
(iii) a processor optical vision system including at least one laser system for observing the application of the coating onto the substrate; and
d. providing a program logic controller configured for cooperating with the control unit, the data cloud, the initial optical vision system, and the one or more processing stations for controlling, in real-time, the application of the coating onto the surface of the substrate.

21. The method of claim 20, comprising providing a plurality of processing systems for applying a series of coatings to one or more substrates moving along the conveyor structure;
providing one or more positioning mechanisms on the conveyor adjacent to each of the processing stations, the one or more positioning mechanisms configured for holding the substrate in place during the application of the coating; and
providing a series of security scanners adjacent to the conveyor for detecting any abnormalities with the substrate or for detecting the presence of a foreign object within a predetermined safe zone, and wherein the one or more of the scanners sends a signal to the control unit to stop movement of the conveyor and/or the robotic unit.

22. The method of claim 20, wherein the robotic unit includes at least the first applicator and a second applicator having at least a second nozzle, the first applicator and second applicator configured for applying at least a first coating, and at least a second coating and wherein the processor optical vision system comprises at least a first laser system and at least a second laser system for observing a shape of the substrate and for monitoring application of at least the first coating and the second coating onto the surface of the substrate and wherein the processor optical vision system communicates the monitored information to the control unit.

23. The method of claim 22, wherein the first laser system and the second laser system observe an amount and/or thickness of coating applied to the surface of the substrate and wherein the control unit is configured for real-time modification of the amount of coating applied to the surface of the substrate.

24. The method of claim 20, comprising providing a plurality of sensors for monitoring and controlling a consumption of the coatings used by the one or more processing stations and for sending consumption data to the control unit, and wherein this data is used to perform a cost analysis of the coatings applied and to optimize the performance of the system.
